(19) United States
(12) Patent Application Publication
(10) Pub. No.: US 2010/0161626 A1
(43) Pub. Date: Jun. 24, 2010

(54) Information retrieval system with contact information appended

(76) Inventors: Craig Harris, Santa Barbara, CA (US); Lonny Rollins, San Luis Obispo, CA (US); Tracy York, Santa Barbara, CA (US)

Correspondence Address: MARK RODGERS, 1590 SAN ROQUE ROAD, SANTA BARBARA, CA, 93105, US

(21) Appl. No.: 12/317,478

(22) Filed: Dec. 19, 2008

(51) Int. Cl. G06F 17/30; G06F 7/00

(52) U.S. Cl. 707/755; 707/E17.014; 707/758

(57) ABSTRACT

The invention is a process for determining contact information for entities meeting specified criteria. An entity profile matching the criteria is pulled from a database. The profile contains at least an entity name and one geographical identifier. The name is parsed and expanded in a fashion to match the possible variations of the name which could conceivably be entries in a directory such as a telephone directory. Entries from the directory within a geographical area of interest containing the identified location from the database profile are checked for duplications or other issues. Where possible, unique contact information is determined and is appended to the entity, and the process is repeated for other entries from the database to create a contact list of entities meeting the specified criteria. In a particular described case, the criteria is a gift amount to a non-profit organization and the geographical identifier is the location of the non-profit receiving the gift.

### RELATED APPLICATIONS

Not Applicable

### FEDERALLY SPONSORED RESEARCH

Not Applicable

### SEQUENCE LISTING

Not Applicable

### BACKGROUND OF THE INVENTION

This invention relates to determining contact information for an entity with a relationship to a subject of interest. In a particular disclosed embodiment, the entity is a donor and the subject of interest is donations made to non-profit organizations.

The Internet by its nature contains a tremendous amount of information. Much of this information, if collected and properly correlated, could be of high value. For instance, an annual report from a non-profit organization, published on the web, may contain a list of donors and the amounts donated. From this list, it would be possible to search the web for further information about the specific donors and the related organization. This research may indicate not only the donor's capacity to give but their affinity or area of philanthropic interest.

Thus a profile of the donor's interests, activities, geographical location and income level may be derived. Such profile information about donors and the organizations a specific donor made donations to, clearly could be of very high value to anyone trying to actively target donation solicitations.

The example of donations to non-profits is used throughout this application, but many variations related to marketing, security, social networking and others share common attributes, namely that starting with source data, other data pertinent to the source data can be found, and the data may be organized into a searchable database. However, in many cases, it is not possible to directly derive information on how to contact entities from the information sources freely available to build the entities' profiles.

A database technique for acquiring such information and thereby identifying entities with known interests and affinities is described in co-pending application Ser. No. 11/827,787, which is incorporated in it's entirety by reference. In a sense, an entity derived from such a database may be considered pre-qualified as a potential prospect for a particular organization. Once an entity such as a donor is identified, and the entity's interests and affinities are known, such as the type of organization donated to and the size of the gift among other facts, organizations, such as similar non-profits, may be interested in propositioning that entity. Thus appending contact information to a list of pre-qualified prospects would be a very useful tool. Obviously known entities potentially constitute far more likely prospects for an organization such as non-profits than any random mailing or telephone solicitation would likely generate. Therefore it is the object of this invention to append contact information to a pre-qualified entity.

### BRIEF SUMMARY OF THE INVENTION

The invention is a process for generating contact information, including the steps of selecting an entity profile from a database based on a predefined selection criteria, wherein the profile includes at least an entity name and one geographical identifier, assigning a geocode to the entity based on the geographical identifier, parsing and expanding the name information to produce a list of possible contact directory entries for the entity, matching the entity with contact information found for the list of entries in the assigned geocode, and determining where possible a unique entry-to-entity match by eliminating duplicate and impossible directory matches.

In a preferred embodiment, the entity is a donor, the predefined criteria is a donation to at least one specific organization and the geographical identifier is the location of the organization receiving the donor's gift. In another preferred embodiment, the directory is a consumer directory, and the contact information is at least one of telephone number, mailing address or email address

In a particular embodiment, the geocode is an area consisting of all or part of a defined group of zipcodes.

In another embodiment, the process includes repeating the above steps to create a contact list of multiple entities in the database matching the predetermined criteria for which a valid directory match is found.

### BRIEF DESCRIPTION OF THE DRAWINGS

The invention will be better understood by referring to the following FIGURE.

FIG. 1 shows schematically the operation of the novel append process

### DETAILED DESCRIPTION OF THE INVENTION

The invention will be described primarily in view of donations and donor prospect research. However, those skilled in these arts will readily appreciate that the teachings disclosed may be applied to other subjects with beneficial results. Thus, the specific examples disclosed should not be assumed as limiting the scope of the invention and appended claims.

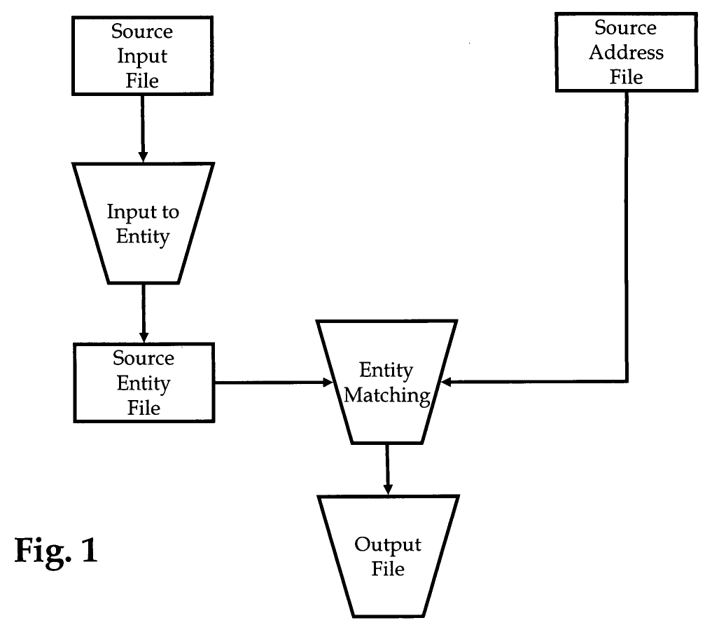

The append system invention assumes the existence of a database containing entity profiles. In particular, the inventors use the novel append process in conjunction with the database described in the above referenced co-pending application, but the append process will work equally well for other databases containing suitable profiles. Referring to FIG. 1 a preferred embodiment of the invention will be described. The source input file, is basically a list of names and some hint of geographical location. The source input file may come from a query to a database for a prequalified group of names, such as donors to a particular organization, but the address append invention is not dependent on the type of source, only the names and location information.

An example source input file is:
P Schaettle, zipcode ABCDE
Peter Schaettle, Donated $1,000,000 to a local Youth Organization in the Santa Barbara Area
Mrs. Betty D. Schaettle, Donated $2,000,000 to the Republican Party that was based in zipcode FGHIJ
Mr. and Mrs. Stephen and Angela Troyer, Graduated from AU and teach at BU
   Each entry is assigned a geocode, which is generally a group of zipcodes in a certain city or county area. Although one zipcode could be used, generally that would be too restrictive for a case such as Peter Schaettle above where the Santa Barbara area may have several zipcodes, or for the Troyers who teach at BU, where commuting distance to BU could encompass many zipcodes. Geocodes may be based on other criteria, for example, such as GPS coordinates, proximity circles, or other political boundaries such as state or national groupings.

The Source Input File is scanned looking for specific Entity Patterns so each input name can be correctly identified and parsed into the known parts of a name. There are occasions where a single Input Name will result in multiple Entity Names. Additionally, during this process each part of an Entity Name is determined into “Last Name”, “First Name”, etc. Any extra information contained in the Source Input File is transferred into the Source Entity File, which for the above Source Input File exploded out to contain only one entity per entry would be:
P Schaettle, Geocode 1234
Peter Schaettle, Donated $1,000,000 to a local Youth Organization in the Santa Barbara Area Geocode 5678
Mrs. Betty D. Schaettle, Donated $2,000,000 to the Republican Party that was based in Geocode 4321
Mr. Stephen Troyer, Graduated from AU and teaches at BU Geocode 7891
Mrs. Angela Troyer, Graduated from AU and teaches at BU Geocode 7891

Entity Matching compares the Source entity file to the Source Address File. The Source Address File, such as a consumer directory contains specific first and last name and address information, for example:
Schaettle, P, 123 Some Street, Somecity, AA, 12345
Schaettle, Peter, 123 Main Street, Santa Barbara, Calif., 93117
Schaettle, Betty, 123 that Avenue, Anytown, BB, 54321
   The point of Entity Matching is to generate an output file of Valid Addresses, such that any address appended has a high confidence value. Thus not all source names will be successfully matched, but the names that are will almost certainly be valid. Examples follow below for source names in mythical Geocode 1.

### EXAMPLE 1

Successful Match
Geocode 1=Zipcodes 12345, 12346, 12347, 12348, 12349
Source Entity File=
Peter Schaettle, 12348
Source Address File Match form Geocode 1=
Peter Schaettle, 123 Main Street, Sometown, USA, 12346
   Thus there is only one match, so the address is assumed valid

### Unsuccessful Match

Geocode 1=12345, 12346, 12347, 12348, 12349
Source Entity File=
Peter Schaettle, 12348
Source Address File=
Peter Schaettle, 123 Main Street, Sometown, USA, 12346
Peter Schaettle, 321 Some Avenue, Anycity, USA, 12349
   Because more than one entry was matched in the Source Address File for Geocode 1, the system is unable to confirm an address.

### EXAMPLE 2

The Source Entity File may contain less specific information than the Source Address file:

### Successful Match

Geocode 1=12345, 12346, 12347, 12348, 12349
Source Entity File=
P Schaettle, 12348
Source Address File=
Peter Schaettle, 123 Main Street, Sometown, USA, 12346

### Unsuccessful Match

Geocode 1=12345, 12346, 12347, 12348, 12349
Source Entity File=
P Schaettle, 12348
Source Address File=
Peter Schaettle, 123 Main Street, Sometown, USA, 12346
Paul Schaettle, 321 Some Avenue, Anycity, USA, 12349

### EXAMPLE 3

Or, the Source Address File may contain less specific information.

### Successful Match

Geocode 1=12345, 12346, 12347, 12348, 12349
Source Entity File=
Peter Schaettle, 12348
Source Address File=
P Schaettle, 123 Main Street, Sometown, USA, 12346

### Unsuccessful Match

Geocode 1=12345, 12346, 12347, 12348, 12349
Source Entity File=
Peter Schaettle, 12348
Source Address File=
P Schaettle, 123 Main Street, Sometown, USA, 12346
P Schaettle, 321 Some Avenue, Anycity, USA, 12349

### EXAMPLE 4

In some cases, extra information in the Source Input File may be used to eliminate alternate matches.

### Successful Match by Elimination

Geocode 1=12345, 12346, 12347, 12348, 12349
Source Input File=
Peter Schaettle and Betty Schaettle, 12348
Source Entity File=
Peter Schaettle, 12348
Betty Schaettle, 12348
Source Address File=
Peter Schaettle, 123 Main Street, Sometown, USA, 12346
Peter Schaettle, 321 Some Avenue, Anycity, USA, 12349
Betty Schaettle, 123 Main Street, Sometown, USA, 12346
Output File=
Peter Schaettle, 123 Main Street, Sometown, USA, 12346
Betty Schaettle, 123 Main Street, Sometown, USA, 12346

Obviously, other criteria and associated algorithms will occur to those skilled in the art beyond the examples presented, and should be considered within the scope of the appended claims.

The output file is the resultant of the matching steps. It is more important to produce valid results than it is to simply have a large output file. For example, the inventors' donation database contains over 35 million Input Names known to have at least once given donations to non-profits. If, for example, that database was queried to provide a source input file of people who gave more than $1000, that number may be reduced. The Address Append will reduce the number further, but a Valid Address output file of even a few million known large donors would be considered gigantic by the standards in the field, and accordingly of very high value.

The above described embodiment has been fully implemented by the inventors and has proven useful commercially in market testing. However one skilled in the art will immediately see alternative embodiments that fall within the scope of the novelty of the invention. For instance, depending on the type of contact information directory used, other contact information might be extracted beyond or in addition to mailing address, such as telephone number or email address. Also “geocode” could be expanded or contracted from the version implemented. Single zipcodes, or city/state/county boundaries could be used, or alternatively, geocode could be expanded to include much larger areas. The larger the area the more duplicates or other invalid addresses will be found as a percentage of the whole, but the actual number of valid contacts may increase. Depending on a particular user's definition, the various validation and weighting steps could be implemented in a variety of ways leading to more or less conservative definitions of “Valid” contact information. Some users may be willing to accept a higher number of invalid contacts to trap more of the valid ones. For instance throwing out duplicate results for the same-name/different-address situation may ensure that non-qualified persons are not contacted, but also almost certainly ensures that a pre-qualified person is not contacted as well.

We claim:

1. A process for generating contact information, comprising;
selecting an entity profile from a database based on a predefined selection criteria, wherein the profile includes at least an entity name and one geographical identifier,
assigning a geocode to the entity based on the geographical identifier,
parsing and expanding the name information to produce a list of possible contact directory entries for the entity,
matching the entity with contact information found for the list of entries within the assigned geocode; and,
determining where possible a unique entry-to-entity match by eliminating duplicate and questionable directory matches.

2. The process of claim 1 wherein the entity is a donor, the predefined criteria is a donation to at least one specific organization and the geographical identifier is the location of the organization receiving the donor's gift.

3. The process of claim 1 wherein the geocode is an area consisting of all or part of a defined group of zipcodes.

4. The process of claim 1 wherein the directory is a consumer directory, and the contact information is at least one of telephone number, mailing address and email address.

5. The process of claim 1 further comprising repeating the steps of claim 1 to create a contact list of all entities in the database matching the predetermined criteria for which a valid directory match is found.
